(19) United States
(12) Patent Application Publication
(10) Pub. No.: US 2011/0238485 A1
(43) Pub. Date: Sep. 29, 2011

(54) METHOD AND APPARATUS FOR UTILIZING CONFIDENCE LEVELS TO SERVE ADVERTISEMENTS

(75) Inventors: Serge Rene Haumont, Helsinki (FI); Kimmo A. Kangas, Kerava (FI)

(73) Assignee: Nokia Corporation, Espoo (FI)

(21) Appl. No.: 13/072,147

(22) Filed: Mar. 25, 2011

Related U.S. Application Data
(60) Provisional application No. 61/318,006, filed on Mar. 26, 2010.

(51) Int. Cl. G06Q 30/00

(52) U.S. Cl. 705/14.41; 705/14.66

(57) ABSTRACT

An approach is provided for serving advertisements to users based on a confidence level of whether the user is in a demographic group. A request is received for initiating an advertising campaign. A confidence level is determined for each representative user of one or more devices that the respective user is a member of a demographic. The advertising campaign is served to devices based on the confidence levels.

### RELATED APPLICATIONS

This application claims the benefit of the earlier filing date under 35 U.S.C. §119(e) of U.S. Provisional Application Ser. No. 61/318,006 filed Mar. 26, 2010, entitled “Method and Apparatus for Utilizing Confidence Levels to Serve Advertisements,” the entirety of which is incorporated herein by reference.

### BACKGROUND

Service providers and device manufacturers (e.g., wireless, cellular, etc.) are continually challenged to deliver value and convenience to consumers by, for example, providing compelling network services. These network services may generate revenue from the network services by presenting advertisements to users of the services. Examples of network services include messaging services, maps and navigation services, social networking services, media services, purchasing services, gaming services, and the like. Advertisements can be positioned in the same screen as an active service presented to a user and/or as in a separate view before, after, or during the use of the service. Typically an advertiser will agree with an ad network to initiate an advertisement campaign. The campaign may be initiated through an automated system such as a self serve interface to an advertisement server, or by meeting and signing a contract. The advertisement campaign may include a number of parameters such as an impression target, number of unique user to be reached, frequency capping, etc. An advertising campaign may be made of different advertising flights each having possibly different validity times and targeted publishers or users. For example, an advertising flight contains at least one advertising creative (e.g. a banner, a text, etc.), but may also contain a more creatives (e.g., thousands of creatives). Although advertisements used in conjunction with these services have become increasingly popular, device manufacturers and service providers face significant technical challenges to increasing the effectiveness of advertisements by targeting specific demographics of users. For example, it may be ineffective to present an advertisement for hearing aids to users in an 18 to 28 year old range. However, currently there is little feedback as to how well advertisements are served to the targeted demographics.

### SOME EXAMPLE EMBODIMENTS

Therefore, there is a need for an approach for serving advertisements to users based on a confidence level of whether the user is in a demographic group.

According to one embodiment, a method comprises determining if an advertising campaign, an advertising flight, or an advertising creative should be targeted to a specific demographic group. The method also comprises determining a confidence level for each respective user of one or more devices that the respective user is a member of a demographic. The method further comprises serving the advertising campaign, an advertising flight, or an advertising creative to the devices based on the confidence levels.

The method may determine the targeted demographic according to information provided by the advertiser, or according to the Click Through Rates measured or according to the conversion rates measured.

According to another embodiment, an apparatus comprising at least one processor, and at least one memory including computer program code, the at least one memory and the computer program code configured to, with the at least one processor, cause, at least in part, the apparatus to receive a request for initiating an advertising campaign. The apparatus is also caused to determine a confidence level for each respective user of one or more devices that the respective user is a member of a demographic. The apparatus is further caused to serve the advertising campaign to the devices based on the confidence levels.

According to another embodiment, a computer-readable storage medium carrying one or more sequences of one or more instructions which, when executed by one or more processors, cause, at least in part, an apparatus to receive a request for initiating an advertising campaign. The apparatus is also caused to determine a confidence level for each respective user of one or more devices that the respective user is a member of a demographic. The apparatus is further caused to serve the advertising campaign to the devices based on the confidence levels.

According to another embodiment, an apparatus comprises means for receiving a request for initiating an advertising campaign. The apparatus also comprises means for determining a confidence level for each respective user of one or more devices that the respective user is a member of a demographic. The apparatus further comprises means for serving the advertising campaign to the devices based on the confidence levels.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of serving advertisements to users based on a confidence level of whether the user is in a demographic group, according to one embodiment;

FIG. 2 is a diagram of the components of user equipment associated with presenting advertisements to a user, according to one embodiment;

FIG. 3 is a diagram of the components of an advertising platform, according to one embodiment;

FIG. 4 is a flowchart of a process for serving advertising based on confidence levels that a user is in a target demographic, according to one embodiment;

FIG. 5 is a flowchart of a process for serving advertising based on confidence level groups, according to one embodiment;

FIG. 6 is a flowchart of a process for modifying confidence levels based on support information, according to one embodiment;

FIG. 7 is a ladder diagram for presenting advertisements according to an advertising campaign, according to one embodiment;

FIGS. 8A-8B are diagrams of user interfaces utilized in the processes of FIGS. 4-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for serving advertisements to users based on a confidence level of whether the user is part of a demographic group are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

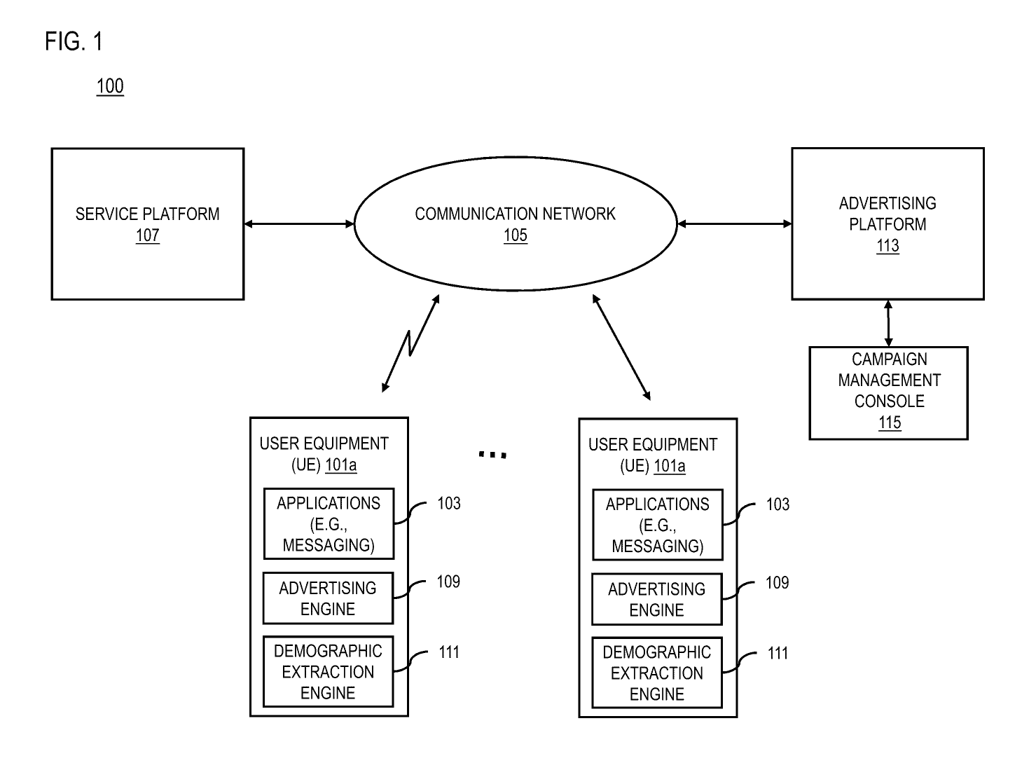

FIG. 1 is a diagram of a system capable of serving advertisements to users based on a confidence level of whether the user is in a demographic group, according to one embodiment. As noted previously, service providers and device manufacturers may generate revenue or otherwise promote additional services, features, products, etc. by presenting advertisements on user devices. Advertisements generally may be presented in association with various applications and/or services such as messaging, navigation, maps, social networking, media (e.g., video, audio, images, etc.), games, stores, etc. For example, a messaging application may display, in a portion of a graphical user interface, the advertisement in parallel with presenting the messaging features.

In one embodiment, advertisements to be displayed to users of devices can be retrieved from an advertising server, stored in a cache of the device, and presented to the user. Advertising engines can retrieve advertisements from the cache to present advertisements with one or more applications. In certain embodiments, an advertising engine is a program and/or hardware resident on a device that can retrieve advertisements from the advertising server and control presentation of the advertisements. The advertising engine can fetch advertisements from an advertising server via an Application Programming Interface (API) to store in the cache for presentation via, for instance, the applications. Further, the advertising engine can provide an API for applications running the advertising engine to request advertisements to present.

Advertisers generally have a demographic target for their advertising campaigns. By way of example, the advertisements can then be provided to specific users who are members of one or more of the target demographics. In certain embodiments, demographics are characteristics of a population. Examples of demographics include age, sex, race, disabilities, mobility, education, home ownership, employment status (e.g., employed, underemployed, unemployed, etc.), location (e.g., urban, suburban, rural, etc.), income level (e.g., middle-class, upper-class, upper-middle-class, poor, etc.), military status, family status, marriage status, vehicles owned, etc. A demographic target and/or demographic group can include one or more demographics and/or demographic ranges as parameters. For example, a demographic group may include males between the ages of 18 and 25. However, it can difficult to target these demographic groups at high certainty because it often is difficult to accurately characterize people using conventional techniques. For example, demographic information is often self-reported by users (e.g., during service registration, etc.) with no independent verification. Accordingly, in many instances, at least some of the users sent advertisements under the campaign may not actually be part of the target group or demographic.

To address this problem, a system 100 of FIG. 1 introduces the capability to serve advertisements to users based on a confidence level of whether the user is in a demographic group. In certain embodiments, a confidence level of whether the user is in a demographic group is the likelihood (e.g., a percentage or other measure) that the user is a part of the demographic group. A confidence level can be based on a normal distribution curve and can be a determination of how reliable and/or repeatable a determination that a user is a part of the demographic group. For example, an algorithm can be utilized to determine the demographic of a user of the device using historical or current data of the user. The historical or current data of the user can include any information available to the user's device, such as where the user has been, the types of advertisements the user clicks through, the websites the user frequents, etc. For example, algorithms can be used to determine that based on the historical data, the user is a male with a 90% confidence. Further, in certain embodiments, the confidence levels of a user being in one or more demographic group can be utilized to determine confidence level groups. Groups can be determined based on thresholds of confidence levels. For example, a high level, medium level, and low level of confidence can each be associated with certain threshold levels (e.g., based on percentages). In this example, the high level can have a threshold that starts at the top threshold level of the medium level and ends at a predetermined level (e.g., 100% confidence). The medium level can have a top threshold at the low threshold of the high level and a low threshold at the top threshold of the low level. Further, the top threshold of the lower level can be at the low threshold of the medium level. The thresholds can be inclusive or non-inclusive. The high, medium, low, confidence level groupings are exemplary and it is noted that more than one intermediate confidence levels can be utilized. The confidence levels and confidence level groups can be utilized to allow campaign managers and advertising service providers more refined targeting of advertisements to users.

The system 100 can comprise user equipment (UEs) 101a-101n that may execute applications 103 such as messaging applications, navigation applications, map applications, social networking applications, media applications (e.g., video, audio, images, etc.), game applications, retail purchasing applications, etc., which may enable presentation of advertisements. It is noted that, in certain embodiments, the advertisements may be displayed directly (e.g., as a system process) without association with an application 103. The approach described herein applies to either situation or any other situation in which advertisement is presented at the UE 101. By way of example, an application 103 is a program that can be executed to perform a task on a UE 101. Some or all of the applications may obtain services (e.g., network services associated with applications 103) via a communication network 105 from a service platform 107.

To provide revenue for the application maker, UE maker, communication network provider, etc., the applications 103, or the UE 101 itself, can be associated with an advertising engine 109. The advertising engine 109 can present advertisements to the user during the execution of the application 103, before execution of the application 103, after execution of the application 103, or a combination thereof. A demographic extraction engine 111 can be utilized to determine a demographic of the user based on one or more algorithm. Further, the demographic extraction engine 111 can determine a confidence level that the user of the UE 101 is a member of the demographic based on one or more algorithms. The advertising engine 109 can populate an advertisement memory via an advertising platform 113. As such, the advertising engine 109 requests one or more advertisements from the advertising platform 113 and receives one or more advertisements from the advertising platform 113. In certain embodiments, the advertisements may be streamed or otherwise retrieved from the advertising platform 113. It is noted that the application 103 or other system processes may perform the actions of the advertising engine 109 or demographic extraction engine 111.

The advertising platform 113 may include advertising content that can be updated via the communication network 105 and/or a campaign management console 115. The campaign management console 115 can be a workstation or other computing device that may be utilized to update the advertising platform 113 (e.g., specify new advertisements, target demographics, dates, etc.). Additionally, the advertising platform 113 can receive a request from the campaign management console 115 and/or another device connected via the communication network 105 to initiate an advertising campaign for a target demographic. Further, the campaign management console 115 can be utilized to present reports as to how an advertising campaign is progressing. The reports may include information as to what the goal of the advertising campaign is (e.g., the target number of unique users or impressions to users present advertisements to associated with the advertising campaign), time period to meet the target, groups of demographics and/or confidence levels associated with those groups, a target rate for meeting the goal over the time period (e.g., a target rate of 100,000 impressions over 10 days would set an expected rate of 10,000 impressions a day), the actual rate at which advertisements are being distributed, etc. Moreover, the campaign management console 115 may additionally be utilized to enter input to manually adjust demographic parameters (e.g., based on progress of the advertising campaign). For example, a campaign manager can set or adjust a demographic based on determined click-through-rates associated with advertisements of the campaign presented to users of UEs 101.

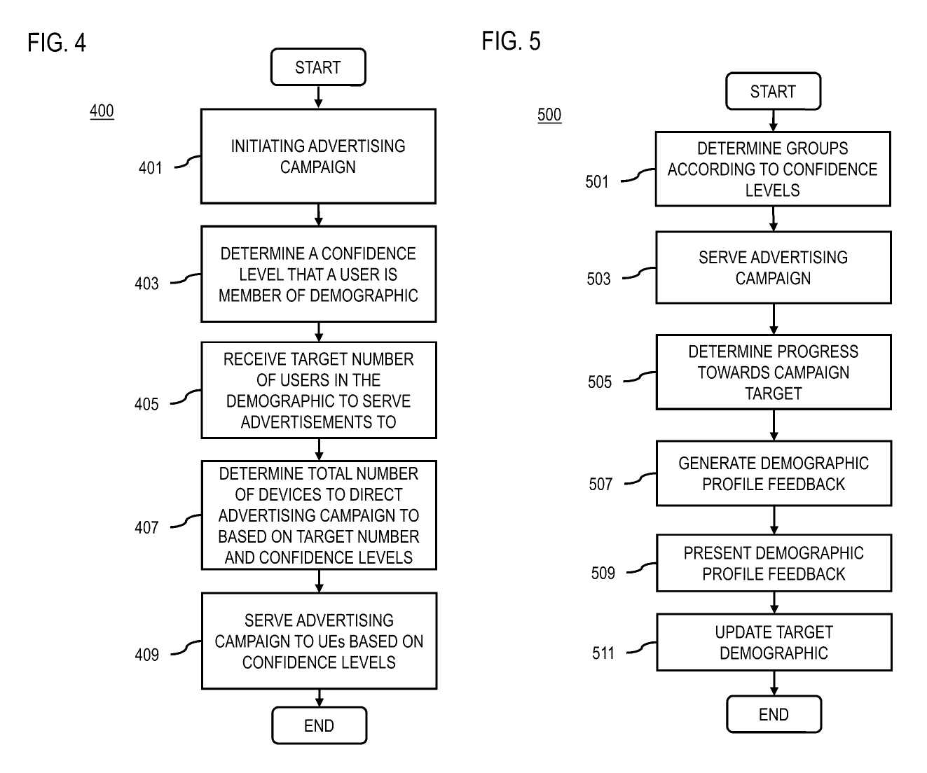

As noted previously, the confidence level that a user is part of a particular demographic can be utilized in conjunction with the target demographic to initiate an electronic advertising campaign. In some embodiments, an advertising campaign is a series of advertisements to convey one or more messages for the advertiser. The advertising campaign can include one or more advertising creatives to present to the users. The confidence levels can be utilized to improve click-through-rates and user experience associated with the advertising campaign as further described in processes of FIGS. 4 and 5.

In certain embodiments, the application 103 enables the use of the advertising engine 109 (e.g., via an API) to present advertisements associated with the application 103. As noted above, the application 103 may present the advertisements in a portion of a graphical user interface (GUI) associated with the application 103. Further, the advertising engine 109 may control advertisements provided to and/or presented by the applications 103. As the advertising engine 109 is used to present advertisements, data can be collected by the advertising engine 109 and/or demographic extraction engine 111. Such data can include, for example, whether the number of impressions of a particular advertisement and/or advertising campaign was made, the number of times the user clicked on one of the advertisements, etc.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, the service platform 107, and advertising platform 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the service platform 107 and/or advertising platform 113 may interact according to a client-server model with applications 103, advertising engine 109, and/or demographic extraction engine 111. According to the client-server model, a client process sends a message including a request to a server process, and the server process responds by providing a service (e.g., messaging, advertisements, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

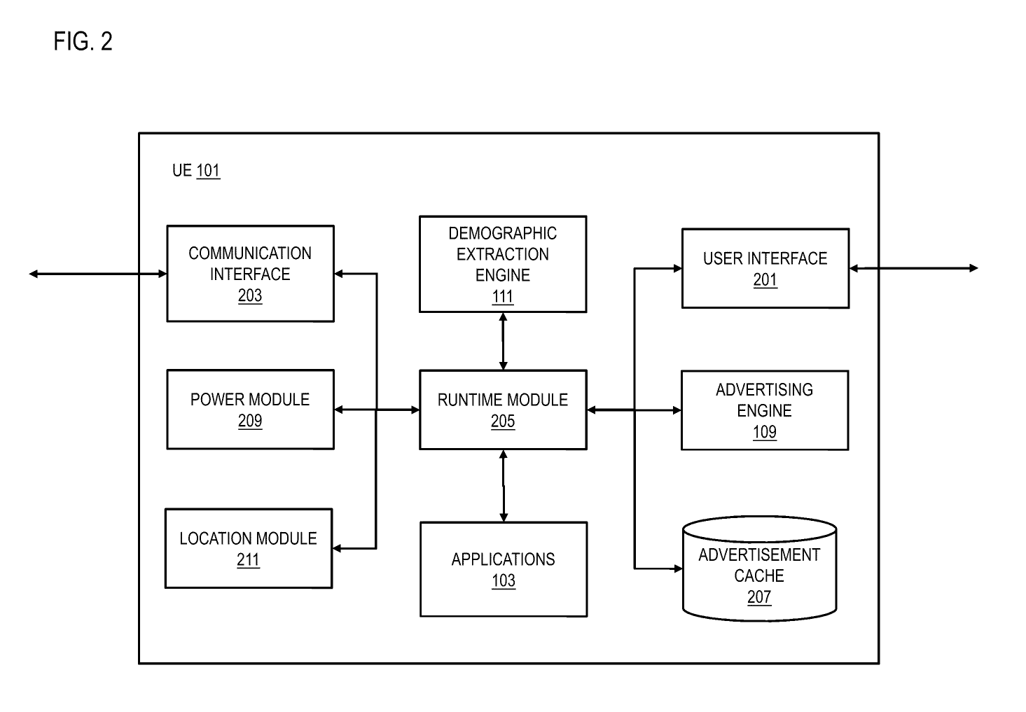

FIG. 2 is a diagram of the components of user equipment associated with presenting advertisements to a user, according to one embodiment. By way of example, the UE 101 includes one or more components for presenting advertisements to a user and reporting use information to the advertising platform 113. It is contemplated that the functions of these components may be combined in one or more components or performed by other components of equivalent functionality. In this embodiment, the UE 101 includes user interface 201 to receive input and provide output at the UE 101, a communication interface 203 to communicate over a network, runtime module 205 to control the execution of applications 103, advertising engine 109, and demographic extraction engine 111 executing on the UE 101, an advertisement cache 207, a power module 209, and a location module 211.

The user interface 201 can include various methods of communication. For example, the user interface 201 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 201 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 201 may be utilized to provide visual output of applications 103 and/or advertisements. As previously noted, the advertising engine 109 can control which advertisements are presented with which applications 103. Advertisements can be presented audibly (e.g., as an audio output), as a visual output (e.g., image, video, or other media), etc. and may be interactive.

The communication interface 203 may include multiple means of communication. For example, the communication interface 203 may be able to communicate over SMS, MMS, internet protocol, instant messaging, voice sessions (e.g., via a phone network), or other types of communication protocols. The communication interface 203 can be used by the runtime module 205 to communicate with other UEs 101, the service platform 107, the advertising platform 113, and other devices. In some examples, the communication interface 203 is used to transmit and receive communication messages to obtain services from the service platform 107 and/or advertisement information from the advertising platform 113. In certain embodiments, advertising information includes advertisements, advertisement creatives, advertising campaigns, demographic information, confidence levels, etc. Further, the advertising engine 109 may utilize the communication interface 203 to update the advertisement cache 207. As such, the advertising engine 109 requests and receives advertisements.

As noted, the UE 101 includes a power module 209. The power module 209 provides power to the UE 101. The power module 209 can include any type of power source (e.g., battery, plug-in, etc.). Additionally, the power module 209 can provide power to the components of the UE 101 including processors, memory, and transmitters. The power module 209 may further provide the runtime module 205 and/or advertising engine 109 with a status of the power supply (e.g., a battery status, such as battery low, a time left for the battery at current power consumption, a percentage of battery power left, etc.).

The location module 211 can determine a user's location. The user's location can be determined by a system such as a GPS, A-GPS, Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 211 may also utilize multiple technologies to detect the location of the UE 101. In certain embodiments, the location information can be utilized by the demographic extraction engine 111 to determine demographic information and/or confidence levels associated with a user of the UE 101.

The demographic extraction engine 111 can determine demographic information associated with one or more users of the UE 101 based on contextual information associated with the UE 101. For example, the applications 103 active on the UE 101 may be utilized to determine contextual information about the user. Further, the current location of the user and/or historical locations of the user can be used to determine demographic information such as the area where the user lives, a location where the user works, areas that the user frequents (e.g., a particular mall), income level information associated with locations the user frequents, etc. Moreover, internet use can be utilized to determine demographic information (e.g., it is more likely that the user is male if the user frequents a male health website). Confidence levels can be determined for these users based on the information gathered (e.g., it may add to the confidence that a user is male if the user uses applications frequently associated with males, it may add to the confidence that the user is female if an analysis of a vocal input associated with the user is high pitched indicating a female voice, etc.).

In one embodiment, the demographic extraction engine 111 is used to determine if a user of the UE 101 is part of a demographic category within a confidence level. The runtime module 205 then causes the communication interface 203 to cause, at least in part, transmission of the confidence level and demographic category to the advertising platform 113. Then, the runtime module 205 can use the communication interface 203 to receive an advertisement based, at least in part, on the demographic category and the confidence level from the advertising platform 113. The advertising engine 109 then causes, at least in part, presentation of the advertisement via the user interface 201. Confidence levels for more than one demographic category can be sent to the advertising platform 113.

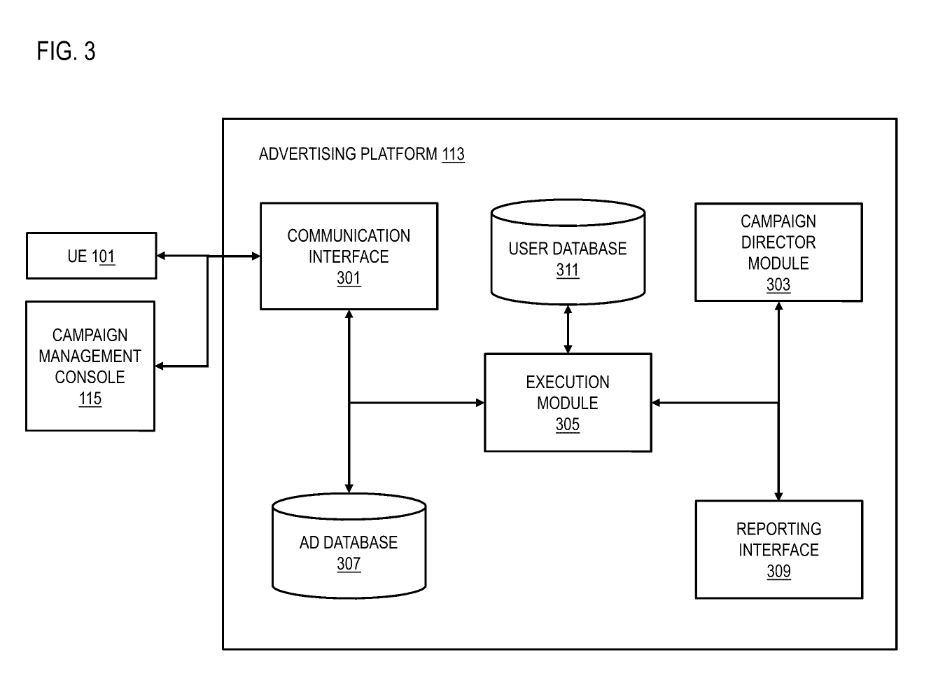

FIG. 3 is a diagram of the components of an advertising platform 113, according to one embodiment. By way of example, the advertising platform 113 includes one or more components for providing advertisement campaigns to UEs 101. It is contemplated that the functions of these components may be combined in one or more components or performed by other components of equivalent functionality. In this embodiment, the advertising platform 113 includes a communication interface 301, a campaign director module 303 that can direct and/or serve an advertising campaign to suitable UEs 101, an execution module 305 that can execute processes and interface between other modules, an advertising database 307, a reporting interface 309, and a user database 311.

The communication interface 301 can be used to communicate with UEs 101, a campaign management console 115, and other devices available over the communication network 105. The execution module 305 can receive information (e.g., a request for advertisements, demographic information, confidence levels, etc.) from the UE 101 via the communication interface 301 via methods such as internet protocol, Multimedia Messaging Service (MMS), Short Message Service (SMS), GPRS, or any other available communication method. Components in the communication network 105 and/or communication interface 301 may be utilized to convert one form of communication to another form (e.g., from an SMS to another form of data).

The campaign director module 303 can be utilized to receive communications from the campaign management console 115 and to obtain advertisement information. As such, an advertising user associated with one or more advertising campaigns may provide advertising creatives as well as parameters for when and/or to whom the advertising creatives should be presented. For example, the advertising creatives can be associated with parameters to show the advertisements based on certain demographic information. The parameters may additionally utilize confidence levels that the user is within a particular demographic to determine whether an associated adverting campaign should be directed and/or served towards the user. As such, the campaign director module 303 can utilize one or more distribution algorithms utilizing the demographic information available and/or associated confidence levels or groupings of confidence levels to determine improve delivery of advertisements associated with the advertising campaign. The user demographic information and/or click-through-rate information about the user, confidence level information, etc. about users can be stored in the user database 311.

Moreover, the campaign director module 303 can receive requests for initiating campaigns as well as target demographic information. The request or subsequent information associated with a campaign can be utilized to populate the advertising database 307. Thus, the advertising database 307 can include one or more advertisements associated with one or more advertising campaigns. The advertising database 307 can additionally include statistical information about one or more of the advertisements and/or advertising campaigns. The statistical information may include click-through-rates or other measures of advertisement activity as well as demographic information and/or confidence level information associated with the statistics. The reporting interface 309 can be utilized to generate and present reports associated with the statistical information gathered in the advertising database 307. These reports can be presented via the campaign management console 115 and/or other UEs 101 or devices communicatively attached to the advertising platform 113.

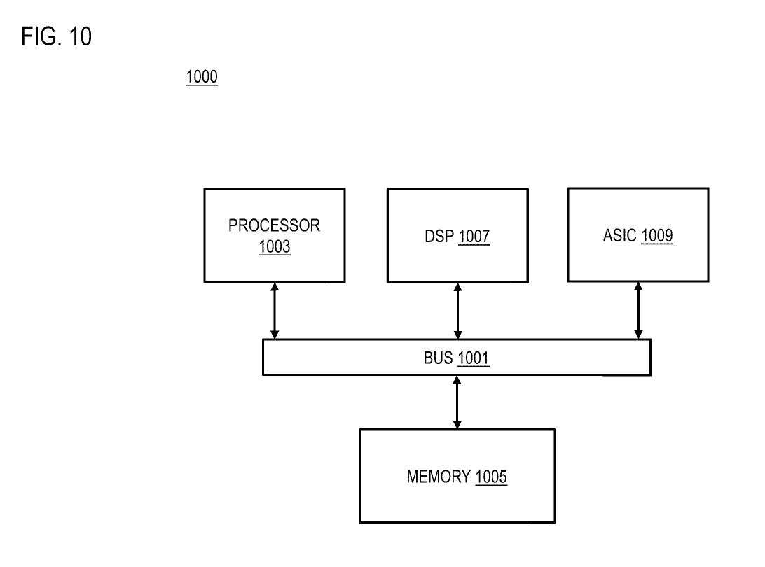

FIG. 4 is a flowchart of a process for directing and/or serving advertising based on confidence levels that a user is in a target demographic, according to one embodiment. In one embodiment, the campaign director module 303 of the advertising platform 113 performs the process 400 and is implemented in, for instance, a chip set including a processor and a memory as shown FIG. 10. As such, the campaign director module 303 can provide means for accomplishing various parts of the process 400 as well as means for accomplishing other processes in conjunction with other components of the advertising platform 113 and/or UE 101.

At step 401, the campaign director module 303 initiates an advertising campaign. This may be based on a request to initiate the advertising campaign (e.g., from a user interface, a message, etc.). The request can include, at least in part, information about a target demographic. The request can be received as a single communication or as an aggregate of multiple communications. In certain embodiments the request is received from a campaign management console 115 or another device in communication with the advertising platform 113. As previously noted, a target demographic can include parameters from one or more demographics. For example, a target demographic can include females between the age of 27 and 33, people living in a particular location, people with a certain salary range, etc. In certain embodiments, the target demographic is unspecified and a demographic is determined to be the target demographic automatically based on effectiveness of campaigns as further detailed in FIG. 5. In some scenarios, the initiation of the advertising campaign is based on a configuration received from the campaign management console 115. As such, the configuration may include a start date and/or time to initiate the campaign.

Then, at step 403, the campaign director module 303 determines a confidence level for each respective user of one or more UEs 101 that the respective user is a member of the target demographic. That is, if the target demographic is a female between the ages of 45 and 52, the campaign director module 303 determines the confidence level that the respective user is a member of that target demographic. This may additionally be accomplished by using algorithms to ascertain the confidence level based on a confidence level of each of a plurality of demographic parameters (e.g., a sex parameter and an age parameter). For example, a type of average, using the lower value of the confidence levels of the parameters, or the like can be used to determine the confidence level a particular user. In certain embodiments, the confidence level and/or confidence levels associated with the parameters can be received from the UE 101 associated with the user (e.g., via the demographic extraction engine 111). As such, the confidence level determined by the campaign director module 303 can be based on the confidence level information received from the UE 101 (e.g., via the demographic extraction engine 111). In other embodiments, the confidence level can be provided by another source, e.g., the advertiser. For example, the advertiser may collect information about users based on surveys. The survey information may be stored in the user database 311 and be associated with the user via one or more unique identifiers (e.g., a telephone number, an e-mail address, social security number, etc.). Further, confidence level information may be input via the campaign management console 115 or UEs 101.

In certain embodiments, at step 405, the campaign director module 303 receives a target number of users and/or or impressions in the target demographic at which the campaign is directed towards. With this information, campaign director module 303 determines a total number of UEs 101 at which to serve the advertising campaign to achieve the target number of users (step 407). The total number of users can be determined based, at least in part, on the target number of users and the respective confidence levels that the users are in the target demographic. For example, if the advertiser wanted to reach 1 million males (the target demographic), the system 100 can be utilized to show the advertiser's campaign to 1 million males with a high level of confidence. In this example, the confidence level of the gender of each user is determined to be 98.3%. In certain embodiments an average confidence level can be associated with each user based on a statistical analysis of the demographic group's confidence. In other embodiments, the confidence level can be individual to each user. The campaign director module 303 can determine the total number of UEs 101 to serve the advertising campaign to by dividing the target number of users to reach by the confidence level. Thus, 1,000,000/0.983 would equal 1,017,293 users that the campaign would need to be directed towards. Further, the total number of users to reach can be based on confidence level groups as described in FIG. 5. With this approach, the system 100 can provide the advertiser with advertisements to the target demographic with little over-serving (e.g., serving more advertisements than necessary to reach the advertiser's goal of reaching 1 million males).

Then, at step 409, the campaign director module 303 serves the advertising campaign to the UEs 101 based, at least in part, on the confidence levels. This may be accomplished by serving the advertisements associated with the campaign to UEs 101 with certain confidence levels that the user of the UE 101 is part of the target demographic. By targeting users with a high level of confidence that the user is in the target demographic, there is a greater chance that the advertisement served to the user via the UE 101 will be affected by the advertisement (e.g., by clicking on the advertisement in an interactive UE 101 advertisement). Further, in the above example with target numbers of users, the total number of users to publish the advertisements to reach the advertiser's target can be reduced by providing the advertisements to UEs 101 with users in a higher confidence level that the user is a part of the target demographic. In this manner, additional advertisement space (e.g., impressions) can be provided to other advertisers and/or other advertising campaigns. Thus, an advantage of directing the advertising campaign to users includes increasing the capacity of the system 100 to electronically deliver advertisements to UEs 101. Further, the campaign director or other components of the advertising platform 113 can act as a means for accomplishing the directing and/or serving. Moreover, this reduces the communications costs and power costs associated with UEs 101 for presenting advertisements that are less likely to affect the respective users of the UEs 101. Additionally, directing and/or serving the advertising campaign based on the confidence levels can include determining the target demographic based on confidence levels and the effectiveness of advertising campaigns to particular demographic groups.

In certain embodiments, the directing includes determining which advertisements to serve UEs 101 requesting advertisements. For example, the UE 101 (e.g., via advertising engine 109) can request an advertisement for a user and send demographic information and/or associated confidence level information. Then, the campaign director module 303 can determine if the user of the UE 101 matches or matches, at least in part, one or more demographic target and/or confidence level associated with one or more campaigns. If the user matches one of the campaigns, the advertising campaign can be assigned to the UE 101. Then, the campaign director module 303 can cause, at least in part, transmission of one or more advertisements associated with the advertising campaign to the UE 101 for presentation.

FIG. 5 is a flowchart of a process for directing advertising based on confidence level groups, according to one embodiment. In one embodiment, the campaign director module 303 of the advertising platform 113 performs the process 500 and is implemented in, for instance, a chip set including a processor and a memory as shown FIG. 10. As such, the campaign director module 303 can provide means for accomplishing various parts of the process 500 as well as means for accomplishing other processes in conjunction with other components of the advertising platform 113 and/or UE 101.

At step 501, the campaign director module 303 determines groups according to confidence levels that a user and/or a UE 101 is associated with a demographic. Each group can be of a particular confidence level for a demographic. An exemplary table, Table 1, is provided to depict confidence level groups in relation to confidence levels and demographics.

TABLE 1

| CONFIDENCE | | |
|---|---|---|
| LEVEL GROUP | CONFIDENCE LEVEL | DEMOGRAPHIC |
| High | Greater than 85% | Age between 18 and 25 |
| Medium | 60%-75% | Age between 18 and 25 |
| Low | Less than 60% | Age between 18 and 25 |

The example of Table 1 shows confidence levels that can be associated with an age group demographic of between 18 and 25 years. The UEs 101 are placed into one of a plurality of confidence level groups according to the confidence level. If the confidence level that the user of a UE 101 is within a confidence level interval of column 2 of Table 1, the UE 101 is grouped into the corresponding confidence level group. For example, if the user of the UE 101 is associated with a confidence level (e.g., 90%) within the interval of the high, the UE 101 is grouped into the high confidence level group. All numbers and thresholds provided in Table 1 are exemplary and can be modified to conform to particular circumstances. Further, the demographic age group is only an example and it is noted that any demographic can be grouped in this manner.

Then, at step 503, the campaign director module 303 serves the advertising campaign. In certain embodiments, the campaign is initially directed towards the UEs 101 of users within the high confidence level group. This is because the users are more likely to be within the target demographic and thus, may be more likely to be affected (e.g., purchase an advertised product) by the advertisement campaign.

The campaign director module 303 can determine progress of the advertising campaign compared to a target rate associated with the advertising campaign (step 505). As detailed in step 405 of FIG. 4, the campaign target can be a target number of user and/or impressions that the campaign is directed towards. As such, the target rate can be an expected rate over the course of time that should be met to meet the campaign target. With this information, the campaign can be served based on the progress of the campaign. If the actual rate at which advertisements are served is close to the target rate or over the target rate, the high confidence demographic groups can be served. However, if the campaign's actual rate is behind the target rate by a certain threshold, the campaign can be directed towards the high confidence level group as well as the next confidence level group below (e.g., the medium confidence level group in Table 1). It is noted that there may be multiple medium confidence level group tiers. Further, if the campaign is further below the target rate, the campaign director module 303 can begin directing the campaign towards the next level down or multiple levels down. Moreover, at a certain point, the campaign can be targeted towards any level of confidence. Further, as the actual rate of progress approaches or moves beyond the target rate, the direction of the campaign can be reduced to groups associated with higher confidence levels.

At step 507, the campaign director module 303 generates demographic profile feedback. To generate the feedback, the campaign director module 303 can receive profile information about a set of users of the UEs 101 who respond to the advertising campaign. In certain examples, this may be a response to the advertisement on the user's UE 101 which provides information that the user clicked on the advertisement. Further, demographic profiles of each of the users and corresponding confidence levels of the responding users (or non-responding users) can be generated. In this manner, a data structure can be populated including each of the responding users' associated demographics as well as the confidence that the user is in that demographic. Further, with this information, the campaign director module 303 identifies a prevalent demographic from the demographic profiles. For example, the target group may be people between the age of 57 and 65, to target hearing aid advertisements. However, it could be noted that many of the persons advertised to that responded to the advertisements were females between the ages of 32 and 39 at a high confidence level, males that live in Florida, etc. In one scenario, the children of the target group may be buying hearing aids for their parents. The additional persons could be targeted as a test group (e.g., a small group selected to test effectiveness of the advertisements) for the campaign director module 303.

At step 509, the demographic profile feedback can be formatted and presented to a campaign manager. A report can be generated and e-mailed, presented on the campaign management console 115, etc. As such, the campaign director module 303 causes presentation of the profile information, the set of users who respond to the advertising campaign, the demographic profiles associated with the users, corresponding confidence levels associated with those demographic profiles, an analysis of the prevalent demographic (e.g., the demographic with the most amount of clicks, the highest click-through-rate), analysis of other positive demographics based on click-through-rate or other feedback, or a combination thereof. The presentation can be formatted as a chart or graph showing analysis information and/or groupings of the persons in the demographic.

Then at step 511, the target demographic is updated by the campaign director module 303. The campaign director module 303 can automatically update the target demographic by specifying another target demographic based, at least in part, on the prevalent demographic, other demographics, or combinations thereof. In this manner, the campaign director module 303 would automatically adjust the campaign serving to different demographic groups based on the realized advertisement clicks. For example, the campaign director module 303 may detect that certain campaigns perform better (e.g., achieves a higher click through rate) in a demographic group “male with high confidence” and thus the ad server may serve these campaigns only to these demographics groups or serve more or more frequent advertisements to these groups. In one example, the original target may be for one demographic for 100% of the campaign, but the campaign can be split to be directed 50% towards the original target demographic, 30% towards the prevalent demographic, and 20% towards another demographic with positive results. Further, there may be no original target and the campaign director module 303 may determine the that certain campaigns perform better in certain demographic groups and the campaign director module 303 directs the campaigns towards the certain demographic groups based on confidence levels associated with the individual users or devices that the user or device is a part of that demographic group. As noted above, the percentages are only exemplary. Further, in certain embodiments, the update of the target demographic can be based on input. For example, an advertiser may see a report of the progress of the campaign and enter input to modify the campaign parameters.

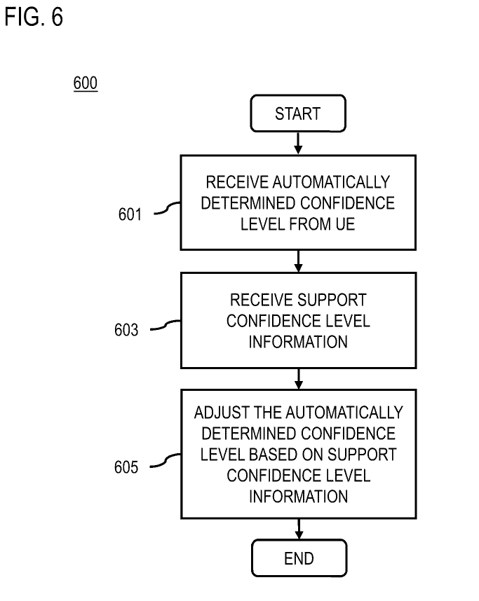

FIG. 6 is a flowchart of a process for modifying confidence levels based on support information, according to one embodiment. In one embodiment, the campaign director module 303 of the advertising platform 113 performs the process 600 and is implemented in, for instance, a chip set including a processor and a memory as shown FIG. 10. As such, the campaign director module 303 can provide means for accomplishing various parts of the process 600 as well as means for accomplishing other processes in conjunction with other components of the advertising platform 113 and/or UE 101. In certain embodiments, the runtime module 205, demographic extraction engine 111, and/or advertising engine 109 of the UE 101 may perform some or all of the steps of process 600.

At step 601, the campaign director module 303 receives automatically determined confidence level information from a UE 101. Confidence level information may include a set of confidence levels for one or more demographics and/or demographic parameters. The demographic extraction engine 111 can determine the demographic parameters as well as the confidence levels associated with the demographic parameters based on one or more algorithms (e.g., an algorithm determining the demographic information based on historical use data, an algorithm for determining the location of the user's home based on GPS data, an algorithm based on other means such as determining the sex of a user based on an analysis of a voice session between UEs 101, etc.). In other embodiments, the confidence level and/or demographic information can be received from another source (e.g., the advertiser, an information collection database service, etc.). These confidence levels can be used as a base confidence level that can be adjusted based on additional information.

Then, at step 603, the campaign director module 303 receives support confidence level information. The support confidence level information can include information that makes it more or less likely that the user of a particular UE 101 is part of a demographic group. In one example, the support confidence level information is self-reported demographic information from the UE 101. The user can enter information into the UE 101 or another device (e.g., via a demographic survey connected to the UE 101 with a unique identifier such as a telephone number or e-mail address). The confidence level from the UE 101 or another base confidence level can then be modified based on the support confidence level information (step 605). With this approach, if the support information agrees that the user is part of a particular demographic (e.g., a target demographic), the confidence level is adjusted to a higher confidence level based on a predetermined factor. If the support information informs the campaign director module 303 that the user is not part of the target demographic, the confidence level can be adjuster lower by a predetermined factor. The predetermined factors can be based on one or more criteria (e.g., how reliable the supplemental information is, what provider the supplemental information is from, etc.). Further, the support confidence level information (e.g., demographic information about the user) may be retrieved from at least one service (e.g., a yellow pages service or third party monitoring service). This support information may additionally be used to modify the confidence level of a user.

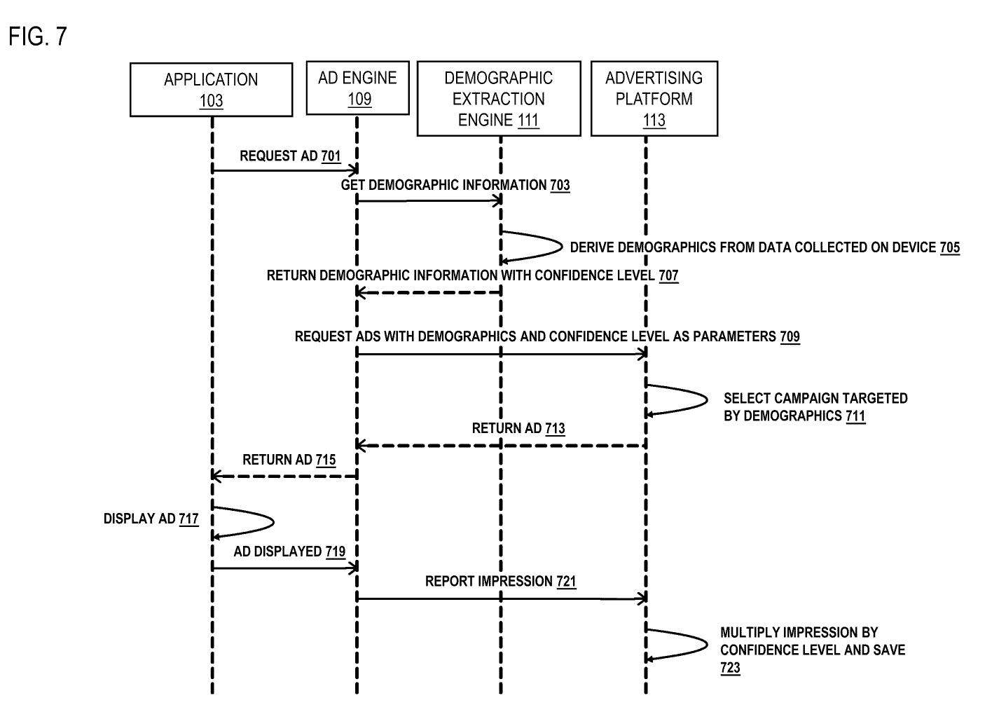

FIG. 7 is a ladder diagram for presenting advertisements according to an advertising campaign, according to one embodiment. A network process on the network is represented by endpoints of the vertical lines. A message passed from one process to another is represented by horizontal arrows. A step performed by a process is indicated by the text. At step 701, the application 103 of a UE 101 requests an advertisement from the advertising engine 109 to present to a user. The advertising engine 109 receives the request and at step 703 requests demographic information associated with the user collected by the demographic extraction engine 111. At step 705, the demographic extraction engine 111 derives demographics from data collected on the UE 101. As previously noted, the data can include the user's movements, the user's activity (e.g., applications utilized, web browsing, etc.). These demographics may change and be updated based on recent activity. Further, a confidence level for the demographics can be determined based on e.g., the consistency of the activity of the user. The demographic extraction engine 111 then returns the demographic information and associated confidence level to the advertising engine 109 (step 707). The advertising engine 109 then requests advertisements from an advertising platform 113 (step 709). The request can include the demographics and associated confidence levels as parameters. In certain scenarios, the request is associated with authentication information provided to the advertising platform 113 to start a communications session to receive advertisements.

When the advertising platform 113 receives the request, the advertising platform 113 can store the demographic information and confidence levels so that each time the advertising engine 109 requests advertisements, the demographics information and confidence levels need not be sent. The advertising platform 113 (e.g., via a campaign director module 303) then selects an advertising campaign to provide to the advertising engine 109 (step 711). The selection of the advertising campaign can be based on one or more of the steps of processes 400, 500, and 600 based on demographic targeting and confidence levels. Once the advertising campaign is selected, one or more advertisements associated with the advertising campaign are delivered to the advertising engine 109 (step 713). The advertising engine 109 can cache the advertisements and/or advertisement campaign for future use. Further, the advertising engine 109 returns an advertisement from the cache and/or received from the advertising platform 113 to the application 103 (step 715). Then, at step 717, the application 103 causes, at least in part, presentation of the advertisement. When the advertisement is displayed, in certain scenarios, the user may interact with the advertisement.

Information that the advertisement was presented (and an impression made to the user) and/or an interaction (e.g., a click on the advertisement) is reported to the advertising engine 109 (step 719). Further, the advertising engine 109 can return the information to the advertising platform 113 (step 721). It is noted, that the advertising engine 109 can accumulate information about displayed advertisements and report an aggregate amount of impressions to the advertising platform 113. The advertising platform 113 can then generate a statistical record of the displayed advertisement. At step 723, the advertising platform 113 multiplies the impression(s) by the confidence level that the impressions were made to a targeted demographic and adds the result to a tally of the number of impressions made to the targeted demographic. In certain embodiments, the tally is of the amount of users the impression is made to instead of the number of impressions. In these embodiments, only one impression per UE 101 is counted. When the tally reaches target limit (e.g., the number of impressions the advertiser has paid for to present to targeted demographics), a new campaign can be begun, a new target may be set (e.g., the advertiser wishes to renew the advertising campaign), or resources can be provided to another advertising campaign.

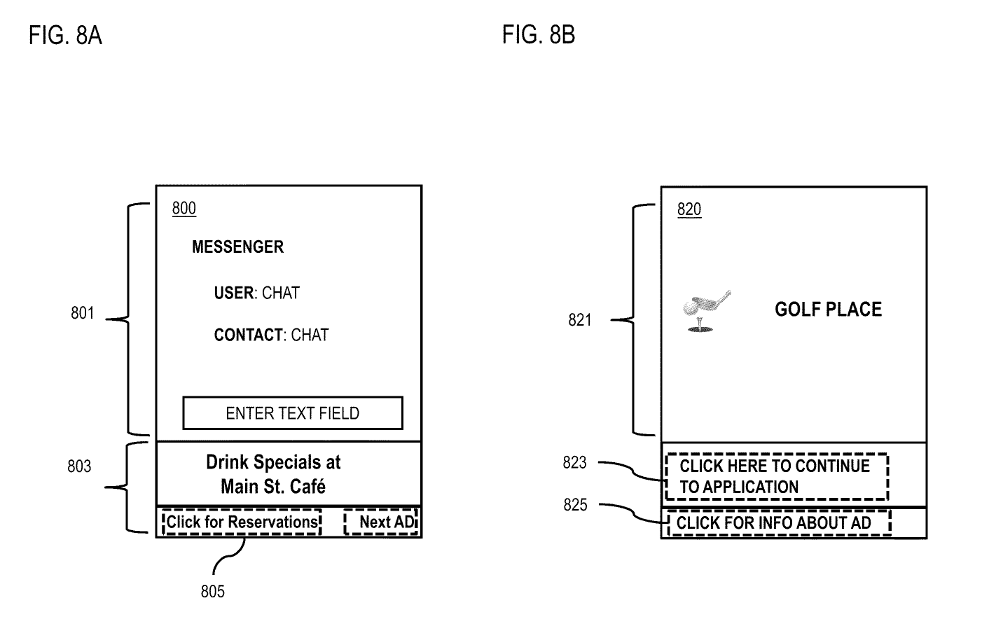

FIGS. 8A and 8B are diagrams of user interfaces utilized in the processes of FIGS. 4-7, according to various embodiments. FIG. 8A shows a user interface 800 with an advertisement displayed during the execution of a messaging application. Application content 801 is presented at the same time as advertisement content 803. Further, the user may click on a portion 805 of the advertisement to access additional content (e.g., make reservations). The advertisement content can be determined for the UE 101 based on a target demographic and/or a confidence level associated with the target demographic. Further, if the user clicks on the portion 805 of the advertisements to access additional content, information about the click can be sent to the advertising platform 113 to optimize campaign direction. Moreover, the additional information can be used to help determine the confidence level that the user is in the target demographic for additional advertisement campaigns.

Further, FIG. 8B shows a user interface 820 with advertisement content 821 displayed separately from application content. As such, the user may choose to continue to the application 823 and/or wait for a given amount of time to continue to the application. Further, the user can click for more information 825 about the advertiser. As in FIG. 8A, when clicked, information about the click can be stored in a memory and returned to an advertising platform 113 as statistical data.

With the above approaches, the advertising provider is able to optimize advertising campaign delivery based on confidence levels (e.g., accuracy information) associated with demographics of users of UEs 101. In this manner, the system 100 is able to provide an advertiser with options to improve click-through-rates or campaign delivery to users in particular demographic groups that may be more apt to be affected by particular advertisements. Further, the advertising platform 113 can reduce processing time and increase efficiency for sending advertisements to a targeted demographic by sending the advertisements to users confident to be in the targeted demographic to an ascertained degree. With the increased efficiency, the advertising platform 113 is able to increase the available advertising space to correctly targeted demographic groups.

The processes described herein for providing advertisements to users based on a confidence level of whether the user is in a demographic group may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

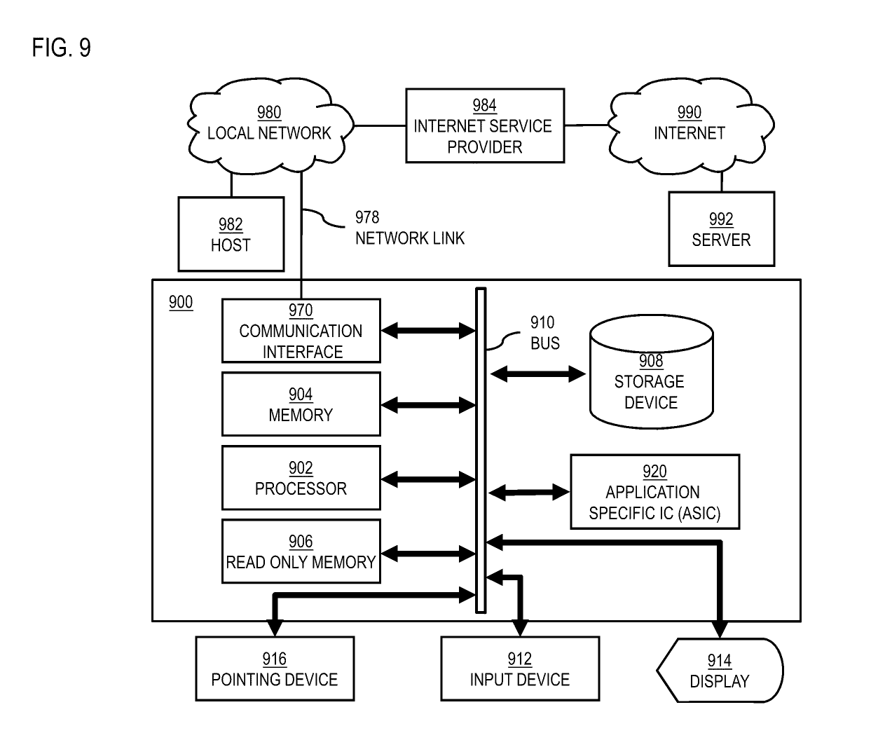

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to serve advertisements to users based on a confidence level of whether the user is in a demographic group as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of serving advertisements to users based on a confidence level of whether the user is in a demographic group.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to serving advertisements to users based on a confidence level of whether the user is in a demographic group. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for serving advertisements to users based on a confidence level of whether the user is in a demographic group. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for serving advertisements to users based on a confidence level of whether the user is in a demographic group, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for serving advertisements to users based on a confidence level of whether the user is in a demographic group to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to serve advertisements to users based on a confidence level of whether the user is in a demographic group as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of services. Chip set or chip 1000, or a portion thereof, constitutes a means for performing one or more steps of serving advertisements to users based on a confidence level of whether the user is in a demographic group.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to serve advertisements to users based on a confidence level of whether the user is in a demographic group. The memory 1005 also stores the data associated with or generated by the execution of the inventive steps.

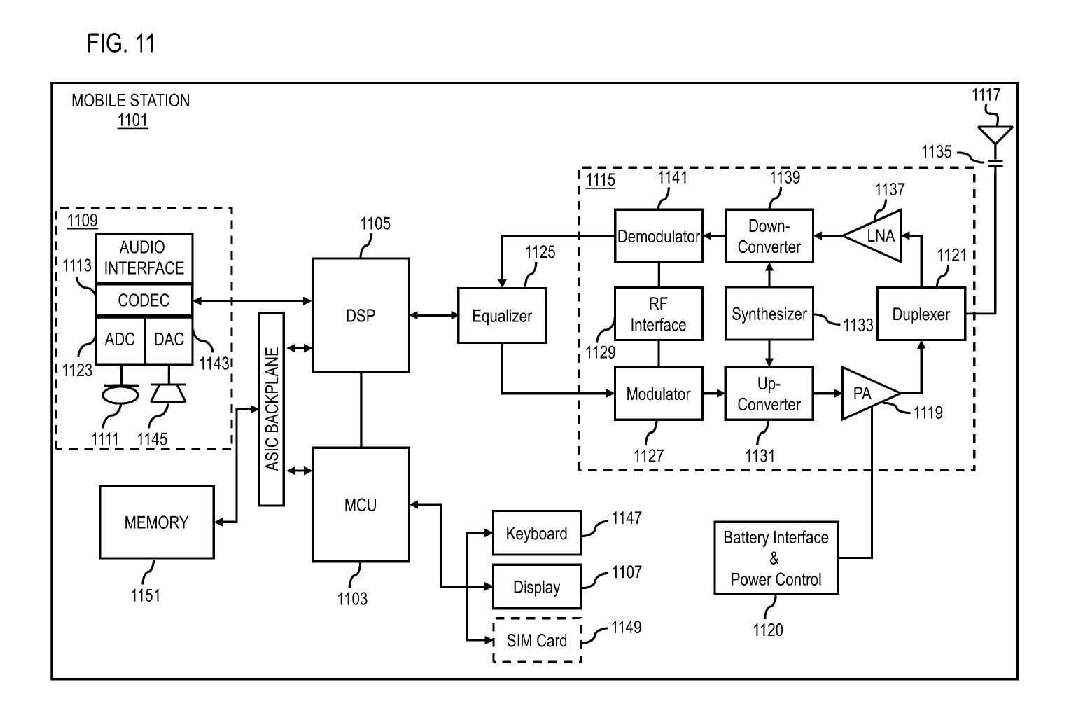

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of presenting advertisements. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of presenting advertisements according to an advertising campaign. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to present advertisements according to a targeted advertising campaign. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating an advertising campaign;
receiving a confidence level for each respective user of one or more devices that the respective user is a member of a demographic; and
serving the advertising campaign to the devices based on the confidence levels.

2. A method of claim 1, further comprising:
placing the devices or the respective users of the devices into a plurality of groups according to the confidence levels; and
determining progress of the advertising campaign compared to a target rate associated with the advertising campaign,
wherein the advertising campaign is served to the groups based at least in part on the status.

3. A method of claim 2, wherein a scope of the advertising campaign is reduced to groups associated with higher confidence levels as the progress approaches or moves beyond the target rate.

4. A method of claim 1, further comprising:
receiving self-reported demographic information from at least one of the users; and
modifying the confidence level determined for the one user based at least in part on the self-reported demographic information.

5. A method of claim 1, furthering comprising:
receiving a target number of users in the demographic at which the advertising campaign is served; and
determining a total number of devices at which to serve the advertising campaign to achieve the target number of users, wherein the total number of devices is based at least in part on the target number of users and their respective confidence levels.

6. A method of claim 1, further comprising:
receiving profile information about a set of the users who respond to the advertising campaign;
determining demographic profiles and corresponding confidence levels of the responding user;
identifying a prevalent demographic from the demographic profiles; and
specifying another demographic based at least in part on the prevalent demographic.

7. A method of claim 6, further comprising:
causing, at least in part, presentation of the profile information, the set of users who respond to the advertising campaign, the demographic profiles, the corresponding confidence levels, the prevalent demographic, or a combination thereof; and
receiving an input, wherein the specifying of the other demographic is based at least in part on the input.

8. A method of claim 1, wherein the confidence levels are determined based on information automatically collected at advertising engines respectively associated with one or more of the devices, on information provided by manual input, or a combination thereof.

9. An apparatus comprising:
at least one processor; and
at least one memory including computer program code,
the at least one memory and the computer program code configured to, with the at least one processor, cause the apparatus to perform at least the following,
initiate an advertising campaign;
receive a confidence level for each respective user of one or more devices that the respective user is a member of a demographic; and
serve the advertising campaign to the devices based on the confidence levels.

10. An apparatus of claim 9, wherein the apparatus is further caused, at least in part, to:
place the devices or the respective users of the devices into a plurality of groups according to the confidence levels; and
determine progress of the advertising campaign compared to a target rate associated with the advertising campaign,
wherein the advertising campaign is served to the groups based at least in part on the progress.

11. An apparatus of claim 10, wherein a scope of the advertising campaign is reduced to groups associated with higher confidence levels as the progress approaches or moves beyond the target rate.

12. An apparatus of claim 9, wherein the apparatus is further caused, at least in part, to:
receive self-reported demographic information from at least one of the users; and
modify the confidence level determined for the one user based at least in part on the self-reported demographic information.

13. An apparatus of claim 9, wherein the apparatus is further caused, at least in part, to:
receive a target number of users in the demographic at which the advertising campaign is served; and
determine a total number of devices at which to serve the advertising campaign to achieve the target number of users, wherein the total number of devices is based at least in part on the target number of users and their respective confidence levels.

14. An apparatus of claim 9, wherein the apparatus is further caused, at least in part, to:
receive profile information about a set of the users who respond to the advertising campaign;
determine demographic profiles and corresponding confidence levels of the responding user;
identify a prevalent demographic from the demographic profiles; and
specify another demographic based at least in part on the prevalent demographic.

15. An apparatus of claim 14, wherein the apparatus is further caused, at least in part, to:
cause, at least in part, presentation of the profile information, the set of users who respond to the advertising campaign, the demographic profiles, the corresponding confidence levels, the prevalent demographic, or a combination thereof; and
receive an input, wherein the specifying of the other demographic is based at least in part on the input.

16. An apparatus of claim 9, wherein the confidence levels are determined based on information automatically collected at advertising engines respectively associated with one or more of the devices, on information provided by manual input, or a combination thereof.

17. A computer-readable storage medium carrying one or more sequences of one or more instructions which, when executed by one or more processors, cause an apparatus to at least perform the following steps:
initiating an advertising campaign;
receiving a confidence level for each respective user of one or more devices that the respective user is a member of a demographic; and
serving the advertising campaign to the devices based on the confidence levels.

18. A computer-readable storage medium of claim 17, wherein the apparatus is caused, at least in part, to further perform:
placing the devices or the respective users of the devices into a plurality of groups according to the confidence levels; and
determining progress of the advertising campaign compared to a target rate associated with the advertising campaign,
wherein the advertising campaign is served to the groups based at least in part on the progress.

19. A computer-readable storage medium of claim 18, wherein a scope of the advertising campaign is reduced to groups associated with higher confidence levels as the progress approaches or moves beyond the target rate.

20. A computer-readable storage medium of claim 17, wherein the apparatus is caused, at least in part, to further perform:
receiving self-reported demographic information from at least one of the users; and
modifying the confidence level determined for the one user based at least in part on the self-reported demographic information.
